(19) United States
(12) Patent Application Publication
(10) Pub. No.: US 2004/0017524 A1
(43) Pub. Date: Jan. 29, 2004

(54) Color display and solar cell device

(76) Inventor: Zili Li, Barrington, IL (US)

Correspondence Address: James A. Lamb, Motorola, Inc. - Law Department, 1303 E. Algonquin Road, Schaumburg, IL, 60196, US

(21) Appl. No.: 10/205,458

(22) Filed: Jul. 25, 2002

(51) Int. Cl. G02F 1/1335

(52) U.S. Cl. 349/106

(57) ABSTRACT

Color displays such as color liquid crystal displays (105) and touch sensitive displays (510) include a substantially transparent back plate (120) or backside and are stacked with one or more solar cells (150) such that light passing through the displays will illuminate the light receiving active surface of the solar cells (150). A pixelized color reflector (121) is used that comprises a patterned color reflector. The resultant display/solar cell can be utilized in combination with a portable electronic device (720) such as a wireless communications device, with the solar cell (150) providing electricity to the display (710), the portable electronic device (720), or both. A mask (810) can be used to occlude surface features on the solar cell (150) as appropriate to provide a substantially uniformly colored appearance.

### CROSS-REFERENCE TO RELATED APPLICATION

This application is related to a co-pending application entitled “A DISPLAY AND SOLAR CELL DEVICE,” U.S. Ser. No. 10/001,495 filed on Oct. 31, 2001, assigned to the assignee of the instant application, and hereby incorporated by reference.

### FIELD OF THE INVENTION

This invention relates generally to liquid crystal displays, touch sensitive displays, and solar cells and also to portable devices having such displays and solar cells.

### BACKGROUND

Various portable devices, including wireless communications devices, utilize a portable energy source such as one or more batteries. Notwithstanding improvements to both battery technology and power consumption of such portable devices, batteries nevertheless represent a finite source of power. Ways to extend (indefinitely if possible) battery life are constantly being sought.

For some devices, solar cells represent a viable supplemental or alternative energy source. Some devices, such as portable calculators, have both sufficiently large available surface area and sufficiently low power needs that some of these devices can be powered entirely by one or more solar cells. Unfortunately, many devices, including for example cellular telephones and other wireless communications devices have both higher power demands and an often-limited available surface area for locating a solar cell. As a result, solar cells have not been viewed as a satisfactory supplemental or alternative power source for such devices.

Some prior art suggestions have been made to combine a solar cell with a display such as a liquid crystal display. Such a combination seems attractive since the display will comprise an ordinary part of the device at issue and the solar cell itself would not require additional surface area. Unfortunately, prior art attempts in this regard have been unsatisfactory. In particular, light that finally reaches the active light receiving surface of the solar cell has been sufficiently attenuated as to substantially mitigate the quantity of electrical power that can be provided by the solar cell even under ideal conditions. The small incremental quantities of supplemental power provided through such prior art attempts have been too small to warrant the additional cost and complexity of providing such a combination in most if not all such devices.

Consequently, a continuing need exists for a way to supplement or replace battery power in portable devices including wireless communications devices in a commercially acceptable and cost-effective manner.

### BRIEF DESCRIPTION OF THE DRAWINGS

This need and others are substantially met through provision of the display and solar cell device disclosed herein. Various embodiments of this device will be better understood upon making a thorough review and study of the following detailed description, particularly when reviewed in conjunction with the drawings, wherein:

FIG. 1 shows an elevation drawing of a first embodiment of a display and solar cell device in accordance with the preferred embodiment of the present invention;

FIG. 2 shows a plan view of a portion of a pixelized color reflector used in the display and solar cell device described with reference to FIG. 1;

FIG. 3 shows a spectral graph of the transmissiveness of the pixelized color reflector described with reference to FIG. 2;

FIG. 4 shows a cross sectional view of a portion of the display and solar cell device described with reference to FIGS. 1-3;

FIG. 5 shows a side elevation drawing of a touch sensitive display and solar cell device in accordance with a second embodiment of the present invention;

FIG. 6 shows a side elevation drawing of a display and solar cell device in accordance with a third embodiment of the present invention;

FIG. 7 shows a block diagram depiction of a portable electronic device including any of the first through third embodiments configured in accordance with the present invention; and

FIG. 8 shows an exploded perspective view of a mask used in conjunction with solar cells in accordance with the embodiments of the present invention.

### DETAILED DESCRIPTION OF THE DRAWINGS

Referring to FIG. 1, an elevation view is shown of a preferred embodiment of a display and solar cell device 100 (herein simply referred to as a device 100) in accordance with the present invention. The device 100 comprises a color liquid crystal display (LCD) 105 and a solar cell 150. The color LCD 105 comprises a liquid crystal display panel, a polarizer 125, and a pixelized color reflector 121. The liquid crystal display panel includes a substantially transparent front plate 110, an opposing substantially transparent back plate 120, liquid crystal material 130, and electrodes (not shown in FIG. 1). The phrase “substantially transparent” means that the plate transmits at least 90% of the infrared and visible light energy that is incident on the front plate 110. For example, the front and back plates 110, 120 can be clear glass which is typically at least 96% transmissive to visible light. Alternatively, the front and back plates 110, 120 can be of substantially transparent plastic, as is well known to one of ordinary skill in the art. Liquid crystal material 130 fills the space between these two plates 10 and 120 in accordance with well-understood prior art knowledge and technique. In this embodiment, the liquid crystal material 130 comprises either supertwisted nematic or twisted nematic liquid crystal material. Electrodes are placed on the surface of the front and back plates 110, 120 in a manner well known in the art to form a pattern of liquid crystal pixels between the front plate 110 and the back plate 120 of the LCD display 105, which is to say that individual pixels are capable of being electronically controlled by a conventional display control circuit (not shown in FIGS. 1-8) to determine an amount of rotation of linear polarized light passing therethrough, in a well known manner. The polarizer 125 is shown in FIG. 1 as being located in front of the front plate 110. It is preferably a linear polarizer that may be bonded to the front plate. The polarizer 125 may alternatively be located between the front plate 110 and the liquid crystal material 130. The surface that is at the front of the LCD display is the front side 118 (e.g., front surface of the polarizer 125). The pixelized color reflector 121 is located substantially parallel to and proximate the back plate 120 of the liquid crystal display panel, preferably behind and adjacent to the back plate 120 of the liquid crystal display panel. The pixelized color reflector 121 can alternatively be located between the back plate 120 and the liquid crystal material 130. The surface that is at the back of the color LCD 105 is the backside 119 of the color LCD 105 (e.g., the backside of the pixelized color reflector 121 when it is behind the liquid crystal display panel). The term “liquid crystal display panel” as used herein is defined to include the substantially transparent front plate 110, the opposing substantially transparent back plate 120, the liquid crystal material 130, and the electrodes for convenience of description and not to indicate that it would necessarily be fabricated and distributed as an entity without including one or both of the polarizer 125 or pixelized color reflector 121, or for that matter, any number of other items included in conventional display panels, such as a compensation plate.

The solar cell 150 is disposed proximal to the backside 119 of the color LCD 105, and a coupling layer 140 joins the solar cell 150 to the color LCD 105. The coupling layer 140 can be, for example, comprised of an appropriate transparent adhesive material as appropriate to a particular application. (For some embodiments, and particularly where vertical thickness comprises a critical form factor, the solar cell 150 may be joined directly to the backside of the color LCD 105.) If desired, and depending upon the area of the liquid crystal display 105 itself and/or desired total power output, multiple solar cells 150 can be utilized as suggested by phantom line 160.

The solar cell 150 has a light receiving active surface as understood in the art. For most applications, the appearance of the liquid crystal display 105 will be enhanced if the light receiving active surface has a uniform appearance and typically a dark-colored appearance. For most applications, a black or substantially black colored surface will be optimum.

Referring to FIG. 2, a plan view of a small portion of the pixelized color reflector 121 is shown in accordance with the preferred embodiment of the present invention. The pixelized color reflector 121 comprises a pattern of color band pixel reflectors 205, 210, 215. Each reflector 205, 210, 215 is shown having a square shape, but it will be appreciated that other shapes could be used, such as bars, circles, or hexagons. The pixelized color reflector 121 shown in FIG. 2 has color band pixel reflectors 205, 210, 215 of three types corresponding to three colors that provide for a full color LCD 105, which in this instance are labeled R for red, G for Green, and B for Blue, but it will be appreciated that other sets of colors could be used, and that as few as two colors could be used for a two color LCD 105. A particular pattern (called herein a delta configuration) of these color band pixel reflectors 205, 210, 215 is shown, but other patterns could be used. For example, other configurations would typically be used for other quantities of colors. An important aspect of this unique invention is that the pixels in the pattern of color band pixel reflectors 205, 210, 215 on this unique pixelized color reflector 121 match locations of pixels of the liquid crystal display panel (which are also pixels of the color LCD 105). This means that the centers of the pixels in the pattern of color band pixel reflectors 205, 210, 215 are substantially aligned with the centers of the pixels of the liquid display panel, and that the conventional display control circuit that drives the pixels of the liquid crystal display correlates the pixels of the liquid crystal display with the colors of the pixelized color reflector 121. Thus, the pixelized color reflector has a pattern of color band pixel reflectors that corresponds to the pattern of liquid crystal pixels.

Referring to FIG. 3, a spectral graph of the transmissiveness of the pixelized color reflector 121 in the lightwave region of the electromagnetic spectrum is shown in FIG. 3. The color band pixel reflectors 205 have a transmissivity curve 305 which characterizes them as being highly reflective in a first color band (herein, red) but being highly transmissive at other visible portions of the lightwave spectrum, as well as the infrared region 320. An analogous situation exists for the color band reflectors 210 and 215, which are characterized by the transmissivity curves 310, 315 showing respective high reflectivities at second and third color bands. Holographic reflector technology, such as Optimax technology developed by Motorola, can be used to fabricate such a pixelized color reflector 121.

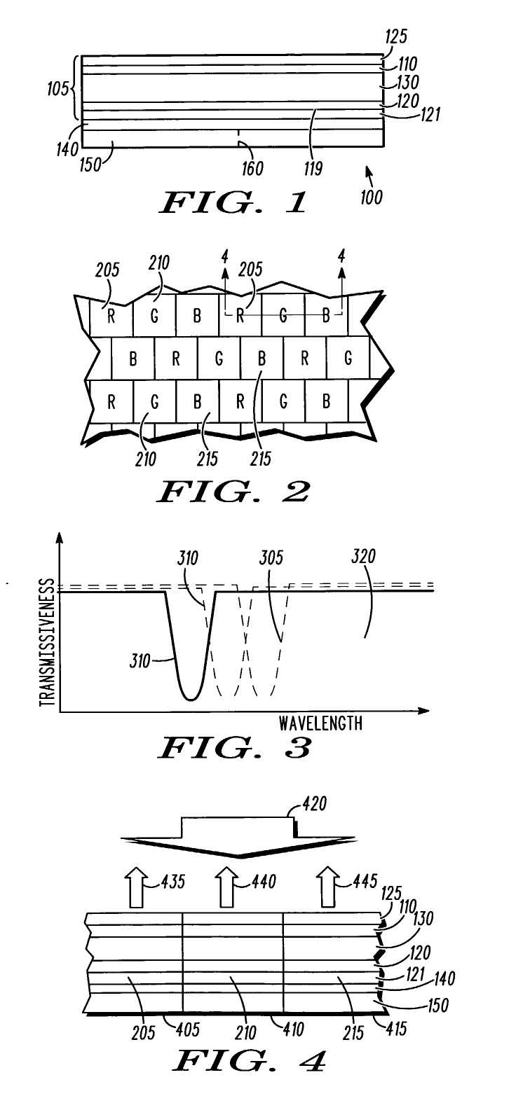

Referring to FIG. 4, a cross-sectional view of a small portion of the display and solar cell device 100 described with reference FIGS. 1-3 is shown in accordance with the preferred embodiment of the present invention. Three pixel regions 405, 410, 415 of the LCD 105. Light 420 that is incident upon the device 100 is represented in FIG. 4 by an arrow. Often in an outdoor situation, energy in the light 420 has approximately equal amounts of infrared (IR) light energy and visible light energy. The light 420 passes through the liquid crystal panel and the polarizer, wherein the visible light energy is attenuated by approximately 50% by the polarizer 125 and plates 110, 120, but wherein the IR light energy is not substantially attenuated by the polarizer 125 and plates 110, 120. Furthermore, the polarization of the light within each pixel region 405, 410, 415 is rotated by an amount determined by the activation of the pixel, as is well known in the art. When the attenuated, polarized light reaches the pixelized color reflector 121, then a portion of the visible light is reflected back through the pixel region 405, 410, 415 including the polarizer 125, resulting in light beams 435, 440, 445 of individual colors (red, green and blue in this example) that have amplitudes that are determined largely by the a mount of polarization of each pixel and the losses in the polarizer 125, front and back plates 110, 120, and the liquid crystal material 135. The color LCD 105 is thereby a full color reflective display.

So configured, at least some of the light 420 passing through the front plate 110 and through the back plate 120 of the reflective liquid crystal display 105 will illuminate the light receiving active surface of the solar cell 150. In this embodiment, where the solar cell 150 has a light receiving active surface that fully extends to the same boundaries as the liquid crystal display 105, approximately 67% of the light energy entering the color LCD 105 reaches the solar cell 150. The 67% energy comprises 50% IR energy and ½ (due to the polarizer 125) of ⅔ (reflected from each color band reflector) of the visible energy). Consequently, depending upon the total area available, considerable electricity can be provided by the solar cell 150 under various normal viewing conditions.

It will be appreciated that the amount of energy that passes into the solar cell 150 in accordance the present invention is substantially greater than that passed into a solar cell using an alternative display and solar cell device configuration that includes a uniform reflector that is essentially transparent to all of the infrared energy but uniformly reflects all the energy of the multiple colors, e.g., red, blue, and green, through a conventional LCD that includes a conventional patterned color filter.

Although the benefit of the present invention in comparison to such an alternative display and solar cell device is achieved by using a more complex, pixelized color reflector instead of a uniform reflector, the present invention eliminates the more complex multicolor filter that is used within the conventional liquid crystal display panel of the alternative display and solar cell device approach. Cost/benefit analysis can determine the best choice of embodiment, depending on uses of the display and solar cell devices.

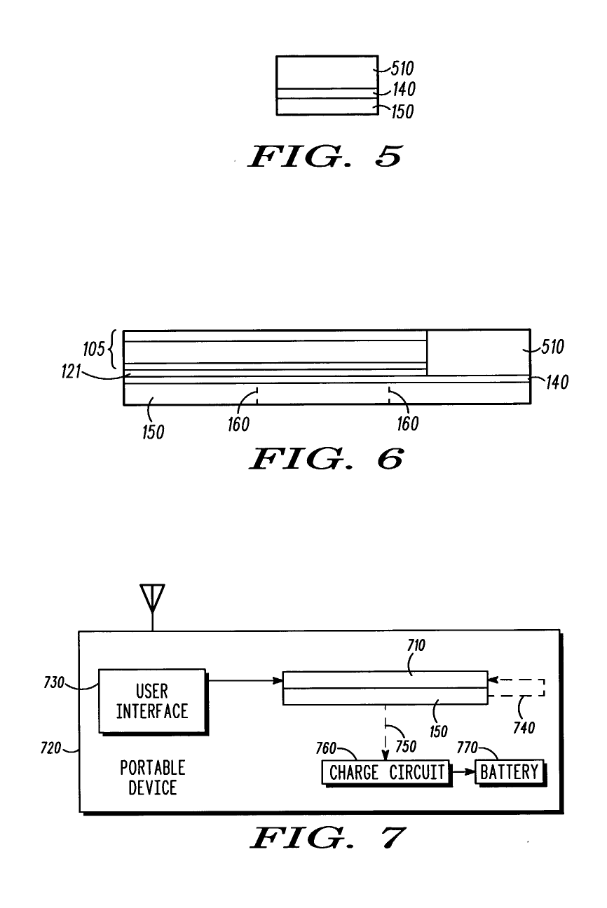

Touch sensitive displays are well understood in the art. Touch sensitive displays ordinarily have a back surface that is colored relatively dark with most consumer products having such a display using a gray color. Pursuant to a second embodiment as depicted in FIG. 5, this back surface of a touch sensitive display 510 can be transparent instead such that light can pass through the back of the touch sensitive display 510 to illuminate the light receiving active surface of a solar cell 150 that is disposed proximal to the backside of the touch sensitive display 510. Again, a coupling layer 140 can be provided to integrate the solar cell 150 with the touch sensitive display 510. So configured, a significant percentage of light entering the touch sensitive display 510 will pass through the transparent backside of the touch sensitive display 510 and illuminate the light receiving active surface of the solar cell 150. The surface of the solar cell 150 should be substantially uniformly colored and can be whatever color is appropriate as the background color for the touch sensitive display (such as gray). “Touch sensitive” as used herein means any technology that is responsive to the use of a finger or pointer to select an area of a display surface, and can include pressure sensing, capacitance sensing, acoustic sensing, or any other technology used for such purpose.

A third embodiment as depicted in FIG. 6 provides a device having both a liquid crystal display 105 and a touch sensitive display 510. Each display 105, 510 can be configured as described above. In the particular embodiment depicted, the liquid crystal display 105 comprises a reflective liquid crystal display using supertwist nematic or twisted nematic liquid crystals. Consequently, this embodiment depicts the liquid crystal display 105 in conjunction with a reflector that comprises a pixelized color reflector 121 as described above. In this embodiment, the liquid crystal display 105 and the touch sensitive display 510 are positioned substantially contiguous to one another along one edge of the LCD display 105. When these displays 105, 510 are contiguous as depicted (or are at least relatively close together) a common coupling layer 140 can be utilized to join a solar cell or cells 150 to both displays 105 and 510. As before, the solar cell or cells 150 preferably have a substantially uniform dark-colored light-receiving active surface such as a black light-receiving active surface. So configured, a significant part of the light entering both through the liquid crystal display 105 and the touch sensitive display 510 will pass therethrough and illuminate the light receiving active surface of the solar cell or cells 150.

In a fourth embodiment, a touch sensitive screen 510 having a transparent back such as that described with reference to FIG. 4 is placed over at least a portion of the front side 118 of the color LCD 105, and may be placed over (be co-extensive with) the entire front side 118 of the color LCD 105. The touch sensitive screen 510 may be bonded to the front of the color LCD 105, or simply attached thereto. This provides a very compact and highly functional display and power supply device.

Depending upon ambient light conditions, the electricity generated by the solar cell 150 in the above embodiments can be considerable. FIG. 7 depicts some ways the display and solar cell devices described above can be utilized. In this embodiment, a portable electronic device 720 such as a portable oscilloscope, an electronic book, a calculator, a cellular telephone, a dispatch two-way radio, a one-way or two-way pager, a wireless personal digital assistant, or the like has a user interface 730 that couples to and drives a display 710. This display 710 can be a liquid crystal display 105 using supertwist nematic or twisted nematic liquid crystal, or a touch sensitive display 510 as disclosed above (or juxtaposed combinations as appropriate to a given application). The display 710 passes light to a corresponding solar cell 150 as taught above. Electricity from this solar cell 150 is coupled 740 to the display 710 to supplement battery power or to substitute for battery power (either temporarily or permanently). In addition, or in the alternative, electricity from this solar cell 150 is coupled elsewhere within the portable electronic device 720 to supplement or substitute for battery power as utilized to power the portable electronic device 720. As one particular example, electricity from the solar cell 150 can be coupled 150 to a charge circuit 760 and used to charge a battery 770 (or batteries) for the portable electronic device 720.

Although only a single solar cell 150 has been commonly depicted for ease of description, it will be readily recognized that a plurality of solar cells could be utilized to provide increased quantities of electricity.

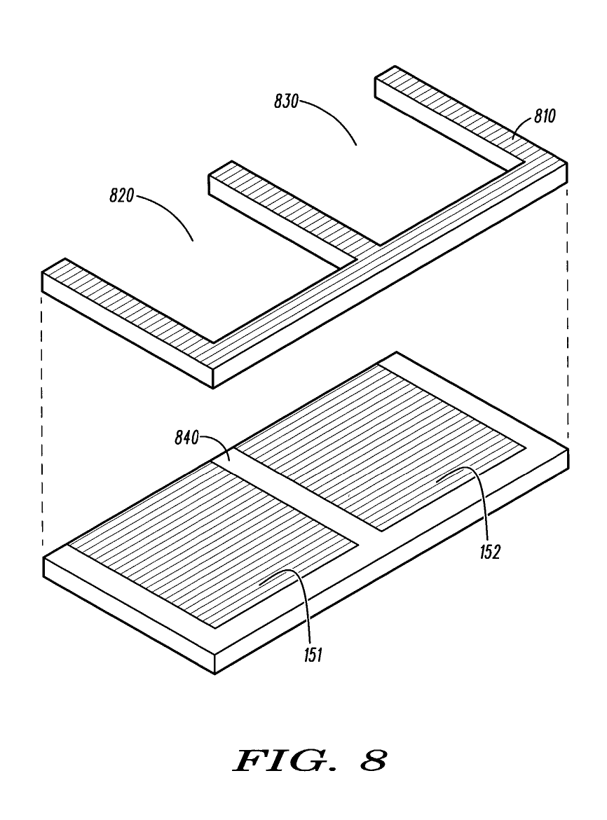

Many solar cells 150 are provided in an integrated package that does not offer a uniformly colored active surface area. Instead, and referring now to FIG. 8, many such packages provide a plurality of solar cells 151, 152 (or regions 151, 152 of a solar cell 150) that are separated by inactive regions 840 made of, for example, copper or other metal. Not only are such materials usually comprised on a color that does not match the color of the active surface regions, but such materials are also usually relatively reflective of visible light. As a result, when placing such a package behind a display surface as taught above, under at least some viewing conditions, these inactive surface regions 840 can be visible through the color LCD 105. When visible in this way, the resultant display can be very distracting to a user.

When using such a solar cell 150, it may therefore be desired to modify the solar cell 150 in order to ensure that the solar cell 150 has a substantially uniform color across at least that part of the solar cell surface that otherwise could be at least partially visible through the display. Pursuant to one embodiment, paint masking technologies can be used to deposit paint on the inactive surfaces to thereby match the color of the solar cells 151, 152. Pursuant to another embodiment, a permanent mask 810 matching the color of the active regions of the solar cells 151, 152 can be provided between the solar cell regions 151, 152 and the color LCD 105 itself. Such a mask 810 should have apertures 820 and 830 to allow light to pass therethrough and contact the active regions 151 and 152 of the solar cell 150. So configured, the mask 810 will cooperate with the solar cell package to allow light to pass through to the active regions while presenting a substantially uniformly colored surface as a background to the display. If desired, the permanent mask 810 can be formed as an integral part of the coupling layer 140 described above.

The display and solar cell devices described provide a more commercially acceptable solution than that offered by the prior art. No surface space of the device to be powered need be uniquely dedicated to one or more solar cells. Instead, the surface space dedicated to the display can serve a parallel purpose in serving as a light collection portal for illuminating the active surfaces of the solar cells. Furthermore, relatively ordinary and cost effective liquid crystal display technologies can now be utilized successfully to provide an acceptable display and nevertheless provide an acceptable level of light to a stacked solar cell. As yet one other advantage, the display will offer protection for the solar cell (such protection will likely be especially meaningful for high efficiency solar panels).

Those skilled in the art will recognize that various alterations and substitutions can be made with respect to the embodiments described without departing from the spirit and scope of the inventive concepts set forth. It is understood that the breadth and scope of the invention is defined only by the following claims.

I claim:

1. A device comprising:
a color display comprising
a liquid crystal display panel having a back plate and a front plate that are substantially transparent, and having a pattern of liquid crystal pixels,
a polarizer, and
a pixelized color reflector disposed substantially parallel to the back plate of the display having a pattern of color band pixel reflectors that corresponds to the pattern of liquid crystal pixels; and
a solar cell having a substantially uniform dark-colored light-receiving active surface disposed proximal to a back plate of the pixelized color reflector such that at least some light passing from the front plate and through the back plate of the pixelized color reflector will illuminate the light-receiving active surface.

2. The device of claim 1 wherein the liquid crystal display panel comprises one of supertwist nematic and twisted nematic liquid crystal material between the back plate and the front plate.

3. The device of claim 1 wherein each of the color band pixel reflectors reflects one of a plurality of color bands and is substantially transparent to light that is not within the one of the plurality of color bands.

4. The device of claim 1 wherein the polarizer is proximal to the front plate of the liquid crystal display.

5. The device of claim 1 wherein the light-receiving active surface is substantially black-colored.

6. The device of claim 1 wherein the solar cell comprises a plurality of solar cell devices.

7. A portable electronic device comprising the device of claim 1, and further comprising a user interface operably coupled to the display.

8. A portable electronic device comprising the device of claim 1 and further comprising a battery that is charged by the solar cell.

9. A portable electronic device comprising the device of claim 1 wherein an electricity output of the solar cell is operably coupled to the portable device.

10. A device comprising:
a touch sensitive display having a substantially transparent backside;
a color display comprising
a liquid crystal display panel having a back plate and a front plate that are substantially transparent, and having a pattern of liquid crystal pixels,
a polarizer, and
a pixelized color reflector disposed substantially parallel to the back plate of the display having a pattern of color band pixel reflectors that corresponds to the pattern of liquid crystal pixels; and
a solar cell having a substantially uniform dark-colored light-receiving active surface disposed proximal to a backside of at least one of the pixelized color reflector and the touch sensitive display such that at least some light passing through at least one of the display and the touch sensitive display will illuminate the light-receiving active surface.

11. The device of claim 10 wherein the liquid crystal display panel comprises one of supertwist nematic and twisted nematic liquid crystal material between the back plate and the front plate.

12. The device of claim 10 wherein each of the color band pixel reflectors reflects one of a plurality of color bands and is substantially transparent to light that is not within the one of the plurality of color bands.

13. The device of claim 10 wherein the polarizer is proximal to the front plate of the liquid crystal display panel.

14. The device of claim 10 wherein the light-receiving active surface is substantially black-colored.

15. The device of claim 10 wherein the solar cell comprises a plurality of solar cell devices.

16. A portable electronic device comprising the device of claim 10 and further comprising a user interface operably coupled to the display.

17. A portable electronic device comprising the device of claim 10 and further comprising a battery that is charged by the solar cell.

18. A portable electronic device comprising the device of claim 10 wherein an electricity output of the solar cell is operably coupled to the portable device.

19. The device of claim 10, wherein the touch sensitive display is co-extensive with substantially the entire display.

20. The device of claim 10, wherein the touch sensitive display is essentially contiguous to the display.
